(19) United States
(12) Patent Application Publication
(10) Pub. No.: US 2005/0000782 A1
(43) Pub. Date: Jan. 6, 2005

(54) Conveyor belt roller for a conveyor

(76) Inventor: Gordon M. McDaniel, Taylorville, IL (US)

Correspondence Address: Polster, Lieder, Woodruff & Lucchesi, L.C., Suite 200, 12412 Powerscourt Dr., St. Louis, MO, 63131-3615, US

(21) Appl. No.: 10/769,928

(22) Filed: Feb. 2, 2004

Related U.S. Application Data
(60) Provisional application No. 60/444,268, filed on Jan. 31, 2003.

(51) Int. Cl. B65G 39/06

(52) U.S. Cl. 198/824; 198/842

(57) ABSTRACT

A conveyor assembly includes a plurality of idler pulleys over which a belt rolls. The idler pulleys are journaled in bearings in side walls of the conveyor assembly. The pulley includes a generally cylindrical center portion or shaft and a stub shaft that is removably mounted to end walls at each end of the pulley shaft. Each stub shaft has a radially disposed flange that is used to removably secure to the stub shaft to the pulley shaft. Additionally, at least one of the bearings for each idler pulley is mounted in an access panel. The access panel is removably mounted to the conveyor side wall and is sized and shaped, such that when they are removed from the conveyor side wall, the pulley stub shaft can be easily reached in order to be removed from the pulley, and the pulley itself can be easily removed from the conveyor, for repair or replacement.

### CROSS-REFERENCE TO RELATED APPLICATIONS

The present application claims priority to U.S. Provisional Patent Application Ser. No. 60/444,268, filed Jan. 31, 2003, the contents of which are expressly incorporated herein by reference.

### BACKGROUND OF THE INVENTION

This invention relates to idler rollers for supporting a flexible conveyor belts, and in particular, such an idler roller which supports a so-called troughed conveyor belt. In particularly, the idler pulley can be easily removed from the support on which it is mounted.

Idler rollers, as is known, are used for, among other things, supporting conveyor belts. A conveyor includes a pair of spaced apart rails (or other supports) which support a plurality of spaced apart idler rollers in spaced apart relation. The idler rollers include a rotating shaft which supports the conveyor belt. Typically, the rails have opposed bearings which receive the shaft or an axle about which the shaft rotates. As shown, the conveyor is a so-called “troughed” conveyor where the sides of a flexible conveyor belt are angled upwardly and outwardly so as to better contain a loose lading, such as grain, on the upper surface of the conveyor belt as the latter moves along the upper reach of its length of travel. As the troughed conveyor belt is entrained around a discharge end roller, the belt may be returned to a “flat” condition for its return run. It will be recognized, however, that the idler pulley of the present invention may be used with flat conveyors as well.

Periodically, the rollers will have to be serviced or replaced. This can be a difficult task, especially in tunnels or covered conveyors where a through shaft cannot be removed. Stub shaft designs have been used which have set screws in hubs. However, the set screws can damage the shaft and are difficult to remove for roller idler replacement.

### SUMMARY OF THE INVENTION

In accordance with one aspect of this invention, an idler pulley is provided for a conveyor. The pulley has a generally cylindrical center portion or shaft and a stub shaft which is removably mounted to the pulley at each end of the shaft. The stub shafts are coaxially mounted with respect to the pulley shaft and with respect to one another such that the stub shafts define an axis about which the pulley will rotate. Each stub shaft has a radially disposed flange fixedly secured to the stub shaft and which is removably mounted to the pulley. Preferably, the pulley includes an end wall at opposite ends of its shaft to which the stub shaft flanges are removably. Additionally, the end walls are spaced inwardly from the ends of the pulley shaft a depth approximately equal to the width of the stub shaft flange.

In another aspect of the invention, the conveyor includes opposed spaced apart side rails or walls and a plurality of pairs of opposed and aligned bearings mounted on each side rail. The idler pulleys are rotatably mounted or journaled in the bearings. Hence, there are two bearings for each pulley. The conveyor includes a plurality of access panels removably mounted in the side rails in which idler pulley bearings are mounted; there being at least one access panel for each idler pulley. The access panels are sized and shaped, such that when they are removed from the conveyor side wall, the pulley stub shaft can be easily reached to be removed from the pulley, and the pulley itself can be easily removed from the conveyor, for repair or replacement.

### BRIEF DESCRIPTION OF THE SEVERAL VIEWS OF THE DRAWINGS

FIG. 1 is an illustrative drawing of an enclosed conveyor assembly;

FIG. 2 is a side elevational view, partly in cross-section, of an idler roller assembly of the present invention mounted in a conveyor;

FIG. 3 is an exploded perspective view of the idler roller assembly;

FIG. 4 is an end elevational view of the idler roller.

FIG. 5 is a side elevational view of a stub shaft of the idler roller assembly;

FIG. 6 is an end elevational view of the stub shaft;

FIG. 7 is an end elevational view of another embodiment of the invention illustrating one end of a conveyor idler pulley (roller) mounted to a conveyor housing by a removable stub shaft in a manner similar to FIGS. 1-6, above;

FIG. 8 is an end elevational view of another embodiment of the invention similar to the embodiment of FIG. 7 except the idler roller has a troughing bell or cone at each end of the idler pulley wherein the troughing bell is mounted with respect to the idler pulley in such manner that the bell is free to rotate relative to the idler pulley, and wherein the idler pulley is mounted on a stub shaft in a manner similar to FIGS. 1-6, above;

FIG. 9 is an end elevational view of still another embodiment of the invention in which a troughing bell or cone is fixedly mounted on the end of the idler pulley and rotates with the idler pulley, and wherein the idler pulley is mounted on a stub shaft in a manner similar to FIGS. 1-6, above;

FIG. 10 is an enlarged view of FIG. 7 showing further details of the manner in which the stub shaft is removably mounted to the idler pulley and in which the stub shaft is journaled in an anti-friction (e.g., roller) bearing carried by a removable access plate forming part of the housing for the conveyor; and

FIG. 11 is another embodiment similar to FIG. 8 in which the troughing cone or bell is divided into two section with each of the sections being free to rotate on the idler pulley and being free to rotate with respect to one another so that the troughing cone can better accommodate the difference in surface speed of the conveyor belt on the troughing roller.

Corresponding reference numerals designate corresponding parts throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

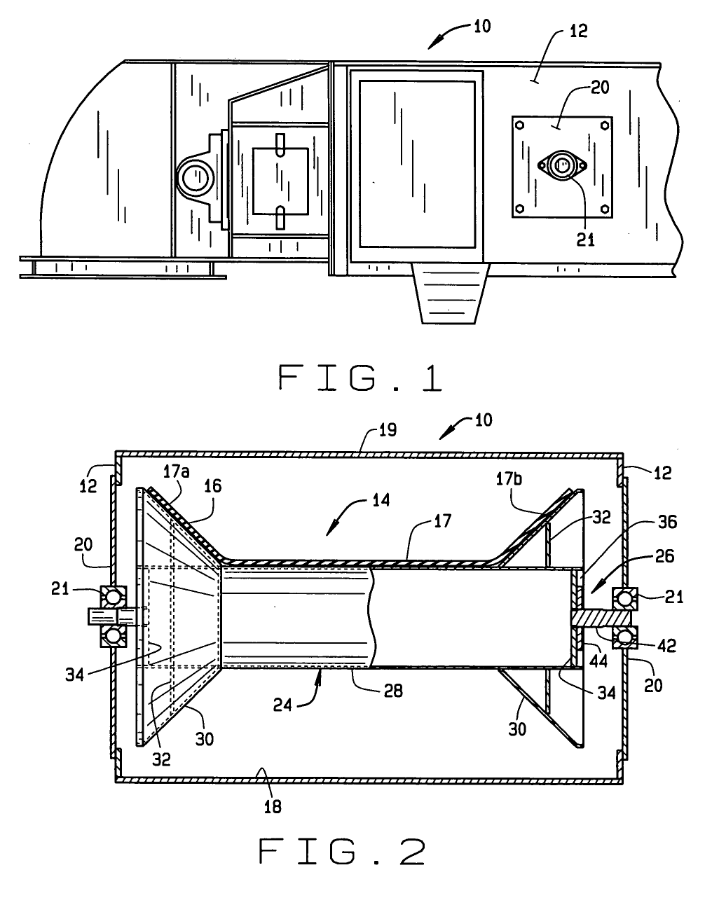

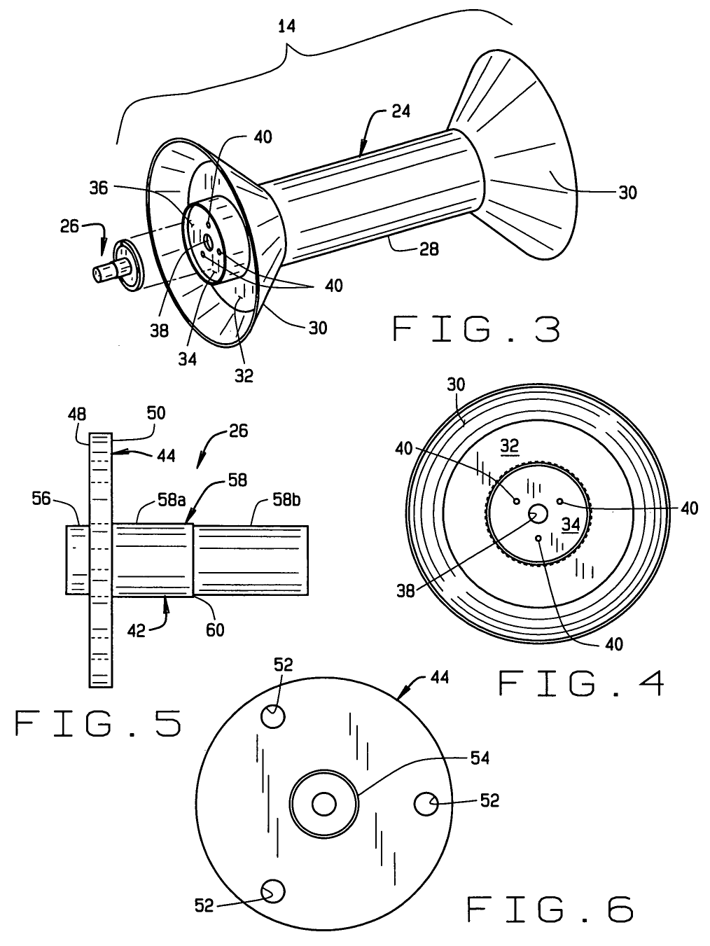

Referring initially to FIGS. 1 and 2, a conveyor assembly 10 generally includes a pair of spaced apart side rails (or other support structure) 12, a plurality of idler rollers or pulley assemblies 14 spaced along the side rails 12, and a flexible conveyor belt 16. In the conventional manner, conveyor belt 16 is an endless belt entrained around a first or inlet roller (not shown) and a second or discharge roller (also not shown). The conveyor belt 16 has an upper reach (as shown in FIG. 2) that is supported on the pulley assemblies 14. The belt 16 also has a lower or return reach (not shown in FIG. 2 for purposes of clarity) below the pulley assemblies 14. As indicated at 17, the conveyor belt 16 has a center, horizontal section which supports the majority of the lading (not shown) on the upper reach and sides 17a, 17b of the belt 16 extend upwardly and outwardly with respect to the center reach 17 for troughing sides for the belt so as to better contain a loose lading on the upper reach. For example, such a loose lading may be grain or the like. Such troughing conveyors can carry a greater amount of the loose lading and the troughing sides effectively prevent or limit spilling of the lading as the belt 16 conveys the lading. To allow the pulley assemblies 14 to rotate, the pulley assemblies 14 are received in bearings 21, which, in turn, are mounted in the rails 12.

If the conveyor assembly is closed, then rails 12 form walls. A floor 18 extends between the rails 12 beneath the pulley assemblies 14 and a cover 19 extends between the rails 12 above the pulley assemblies 14. In the conveyor assembly 10 of the present invention, an access panel 20 is provided to allow for access to each pulley assembly 14. The bearings 21 are mounted in the access panel 20 in a position to be coaxial with each pulley assembly 14. The pulley assemblies 14 are mounted in the bearings 21, as noted below, to enable the pulley assemblies 14 to rotate relative to the conveyor housing.

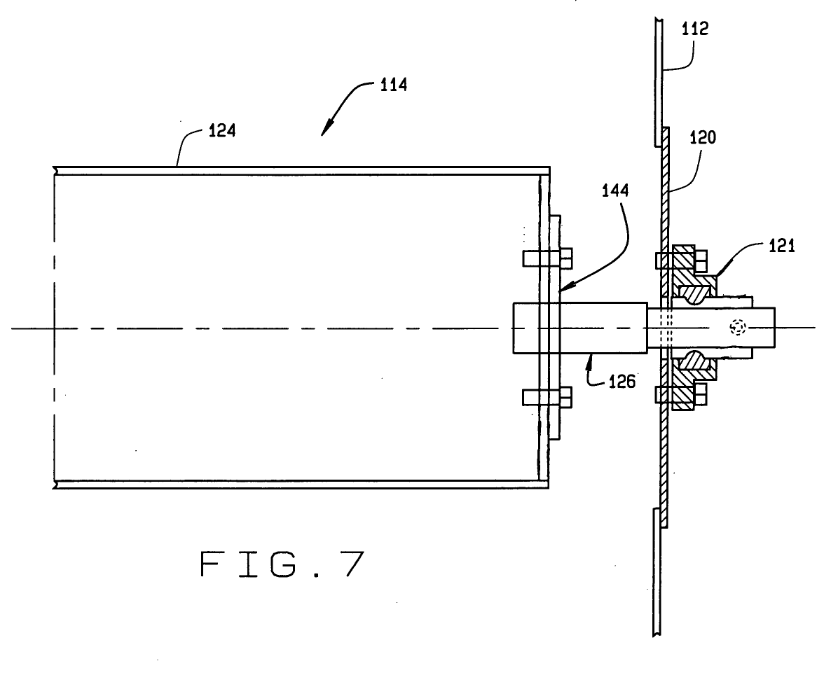

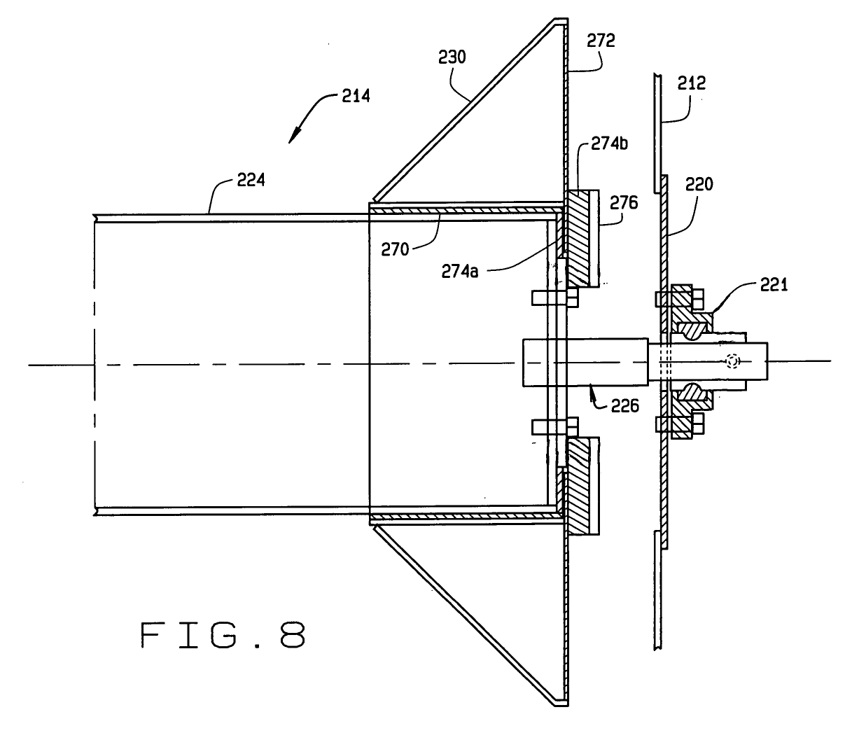

In FIGS. 2-4, a pulley assembly 14 of the present invention includes a idler pulley or pulley 24 and a removable stub shaft 26. The stub shaft 26 is received in the bearing 21. The pulley 24 includes a central tube or shaft 28 with a bell or cone 30 mounted to each end of the shaft 28. The bells 30 are mounted such that their surfaces slope upwardly and away from the shaft 28, to give the conveyor belt 16 a trough-shaped configuration when placed over the pulleys 24. The bells 30 are mounted to the shaft 28 such that the outer edge of the bell 30 is generally flush with the end of the shaft 28. That is, the shaft 28 does not extend beyond the end of the bell 30; and the bell 30 does not extend beyond the end of the shaft 28. To help support the bell 30 (which is hollow), an annular plate 32 is mounted about the shaft 28 approximately midway between the inner and outer ends of each bell 30. The plate 32 extends from the shaft 28 to the inner surface of the bell 30. A shaft end plate 34 is mounted inside the shaft 28 and spaced inwardly from the end of the shaft 28 a short distance to form a pocket 36 at the end of each shaft 28. The end plate 34 has a central opening 38 and three bolt openings 40. The shaft 28, bells 30, support plate 32 and idler plate 34 are all preferably welded together.

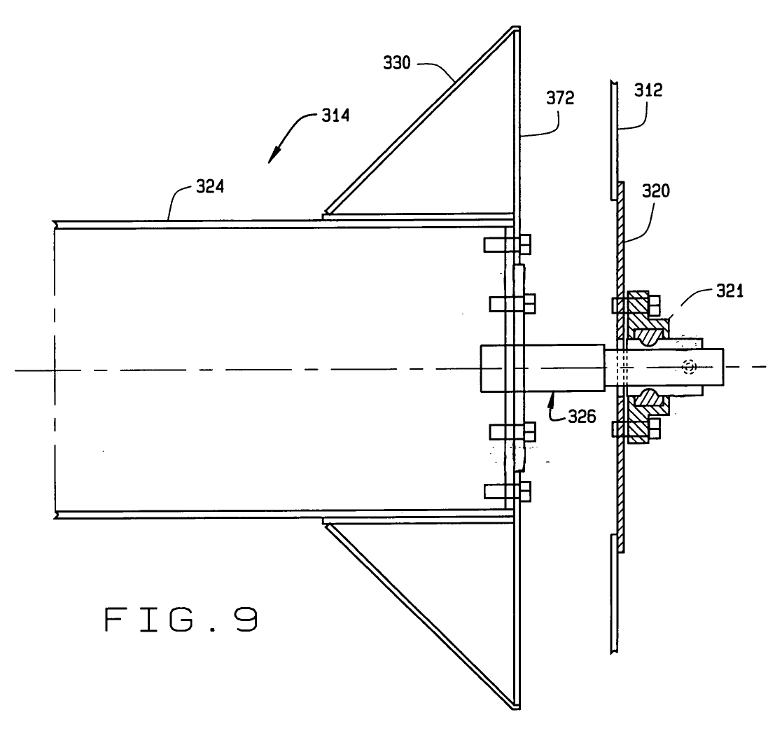

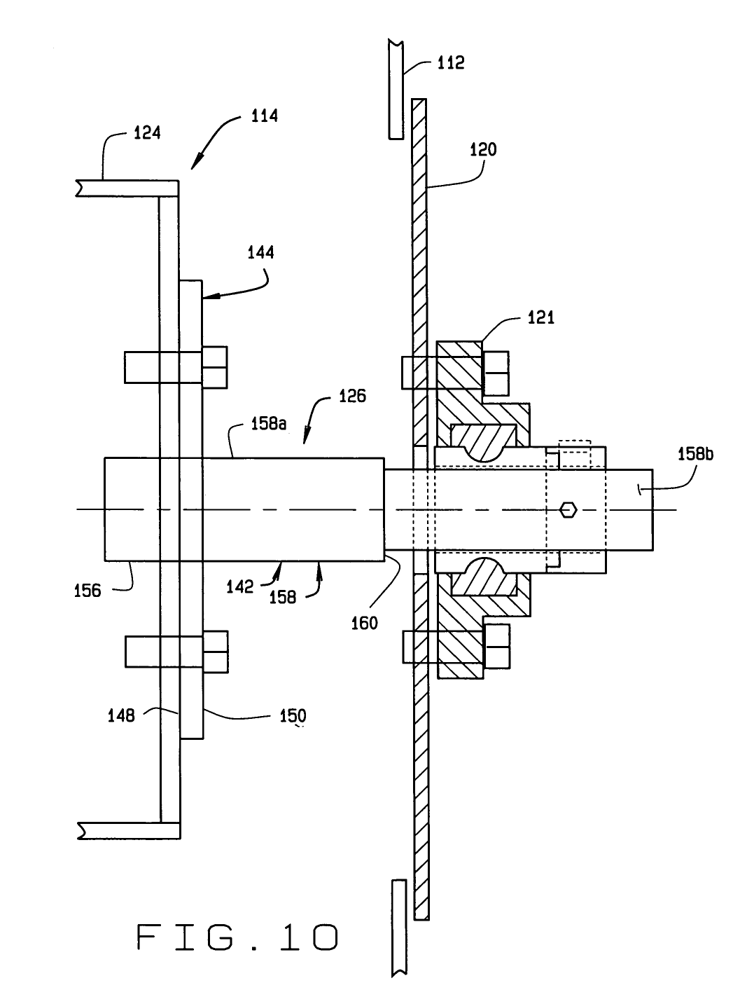

Turning to FIGS. 5 and 6, the stub shaft 26 includes a shaft 42 and a flange or plate 44 that is fixed to the shaft 42, such that the plate 44 and shaft 42 are concentric with each other. If the shaft 42 and plate 44 are separate parts, welding or other conventional means can fix them together, for example. If the stub shaft 26 is a molded part, then the shaft 42 and plate 44 can be molded as a one-piece integral part. The plate 44 includes an inner surface 48 and an outer surface 50 and three bolt holes 52 that are sized, shaped, and positioned to be aligned with the bolt holes 40 on the idler shaft end plate 32. The plate 44, if made separately from the shaft 42, includes a central opening 54 sized to receive the shaft 42.

The shaft 42 includes an inner stub 56 that extends a short distance from the inner surface 48 of the plate 44. The inner stub 56 is sized to be received in the central opening 38 of the idler shaft end plate 34. The shaft 42 also includes an axle portion 58 that extends from the plate's outer surface 50. The inner stub portion 56 and the outer axle portion 58 of the shaft 42 are preferably formed as a single member. The axle portion 58 is stepped down to form a shoulder 60 and to divide the axle portion 58 into an inner portion 58a and an outer portion 58b, the outer portion 58b being slightly smaller in diameter than an inner portion 58a. The axle outer portion 58b is sized to be received in the bearing 21 in the conveyor rail or wall 12. When assembled to the bearing 21, the axle shoulder 60 engages an end wall of the bearing 21, and hence, functions as a stop to limit the extent to which the shaft 58 extends into the bearing 21.

The stub shaft plate 44 is sized and shaped to be received in the pocket 36 defined by the idler shaft end plate 34 and the shaft 28. That is, the plate 44 has a diameter slightly less than the inner diameter of the idler shaft 28. The stub shaft 26 is removably fixed to the pulley 24 using bolts that pass through the bolt holes 40 and 52 of the end plate 34 and shaft plate 44, respectively. The bolt holes 40 of the idler shaft end plate 34 can be replaced with threaded rods that extend from the end plate 34 and pass through the bolt holes 52 of the stub shaft plate 44. A nut can then threaded over each threaded rod to removably secure the stub shaft 26 to the idler roller 24.

As shown in FIG. 2, the side wall 12 of the conveyor assembly 10 is preferably provided with the openable or removable access panel 20 adjacent each pulley assembly 14. The access panel 20 is sized and shaped such that when the panel 20 is removed, there is an opening in the side wall 12 sufficiently large to allow for the pulley assembly 14 to be passed through the wall. As seen, a bearing 21 is mounted on the access panel 20. The outer portion 58b of the stub shaft 42 is received in the bearing 21 to enable the pulley assembly 14 to rotate. Thus, when the access panel 20 is removed from the side wall 12, the bearing 21 associated with the pulley assembly 14 will be removed. This will allow access to the stub shaft 26, and the stub shaft 26 can be easily removed from the idler roller 24 by removing the nuts or bolts which hold the stub shaft 26 to the end plate 32 of the shaft 28. Once the shaft 28 has been removed, the pulley 24 can be withdrawn from the conveyor assembly without difficulty.

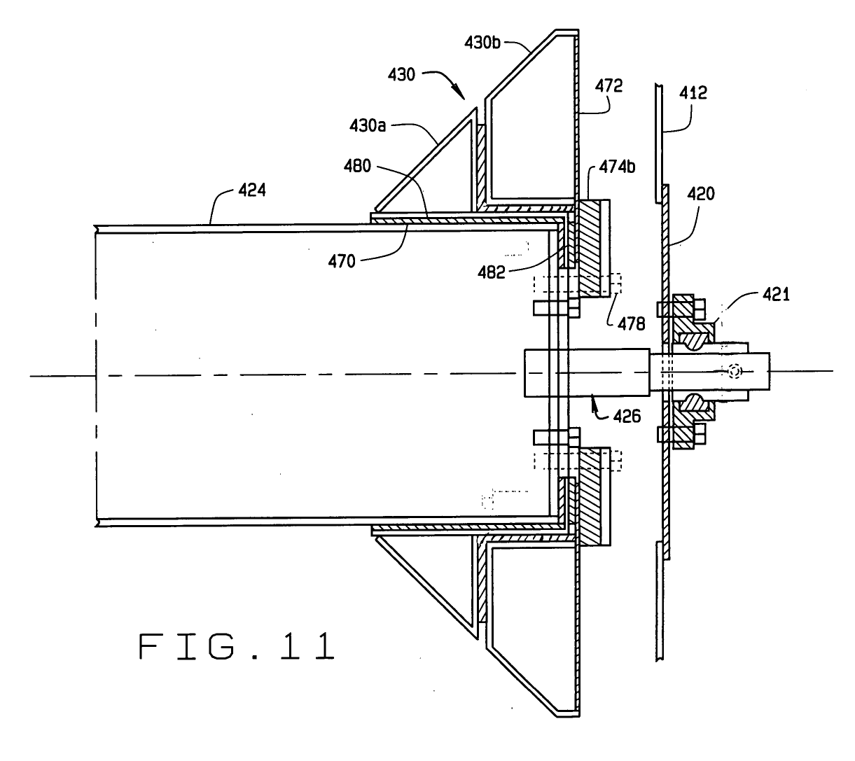

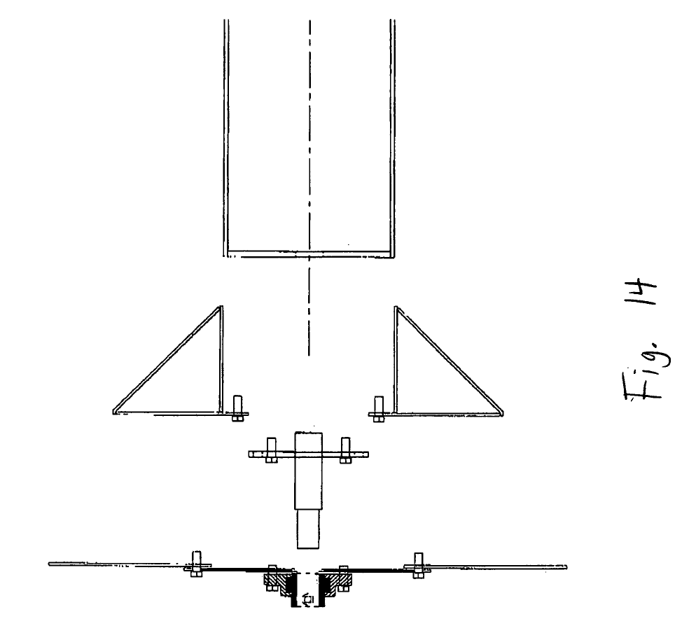

Referring now to FIGS. 7 and 10, another embodiment of the pulley assembly of the present invention is shown and is illustrated in its entirety at 114. Parts in FIGS. 7 and 10 having a similar structure and/or function to parts described in regard to FIGS. 1-6 will be designated by reference characters “1XX” and their structure and function will not be herein again described for purposes of brevity. It will be noted that pulley 124 is substantially cylindrical along its length and it has no troughing bells or cones mounted thereon.

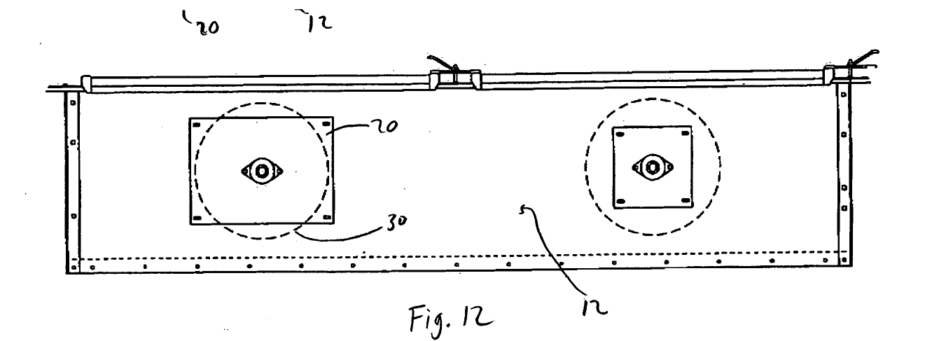

In FIG. 8, another pulley assembly, as indicated at 214 is shown. Parts in FIG. 8 having a similar structure and/or function to parts described in regard to FIGS. 1-7 and 10 will be designated by reference characters “2XX” and their structure and function will not be herein again described for purposes of brevity. As shown, a troughing bell or cone 230 is loosely mounted with respect to pulley 224 so that the troughing bell is substantially free to rotate with respect to the pulley 224. As indicated at 270, a bearing sleeve is mounted on the outer surface of the pulley 224. This bearing sleeve is preferably made of a suitable bearing material, such as ultra high molecular weight (UHMW) polyethylene or the like, thus enabling the troughing bell to rotate on the pulley 224. As shown at 272, the troughing bell 230 has an outer end plate which extends radially inwardly of the outer surface of the pulley 224 with the inner reaches of the end plate 272 loosely held captive between opposed blocks 274a, 274b of suitable bearing material (e.g., UHMW polyethylene or the like). The outermost bearing member 274b is secured to the outer end face of the pulley 224 by means of a plate 276 and bolts 278. In this manner, the troughing cone is free to rotate relative to the pulley 224, but the cone is substantially held in a fixed axial position with respect to the pulley 224.

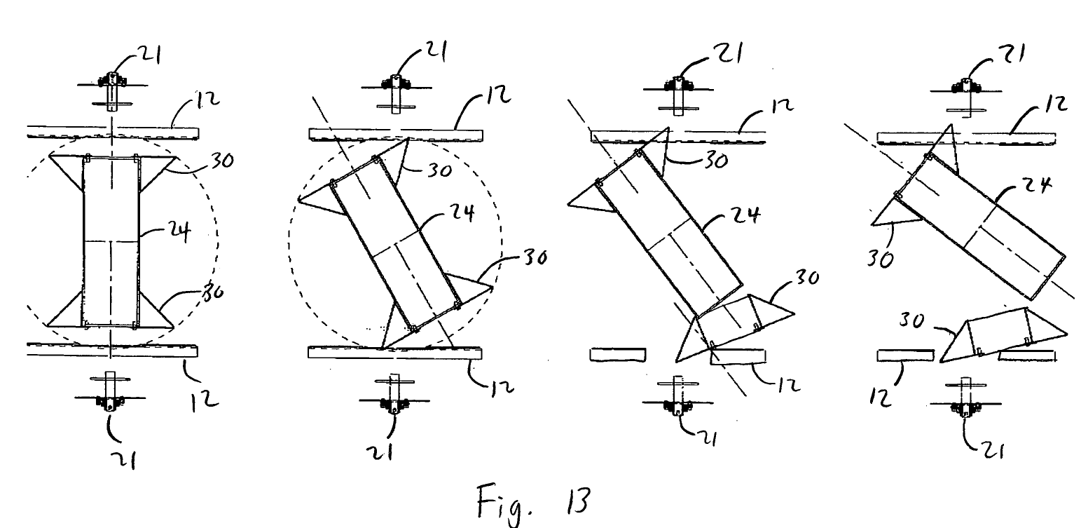

Referring now to FIGS. 9 and 14, still another embodiment of the present invention is shown. Here, a troughing bell or cone 330 is fixedly mounted on each end of pulley 324. The bell 330 has an end plate 372 which extends radially inwardly of the pulley 324 and is bolted to the outer end face of the pulley 324 by bolts 378. The pulley 324 is journaled on the conveyor housing in a manner similar to that described in regard to the other embodiments.

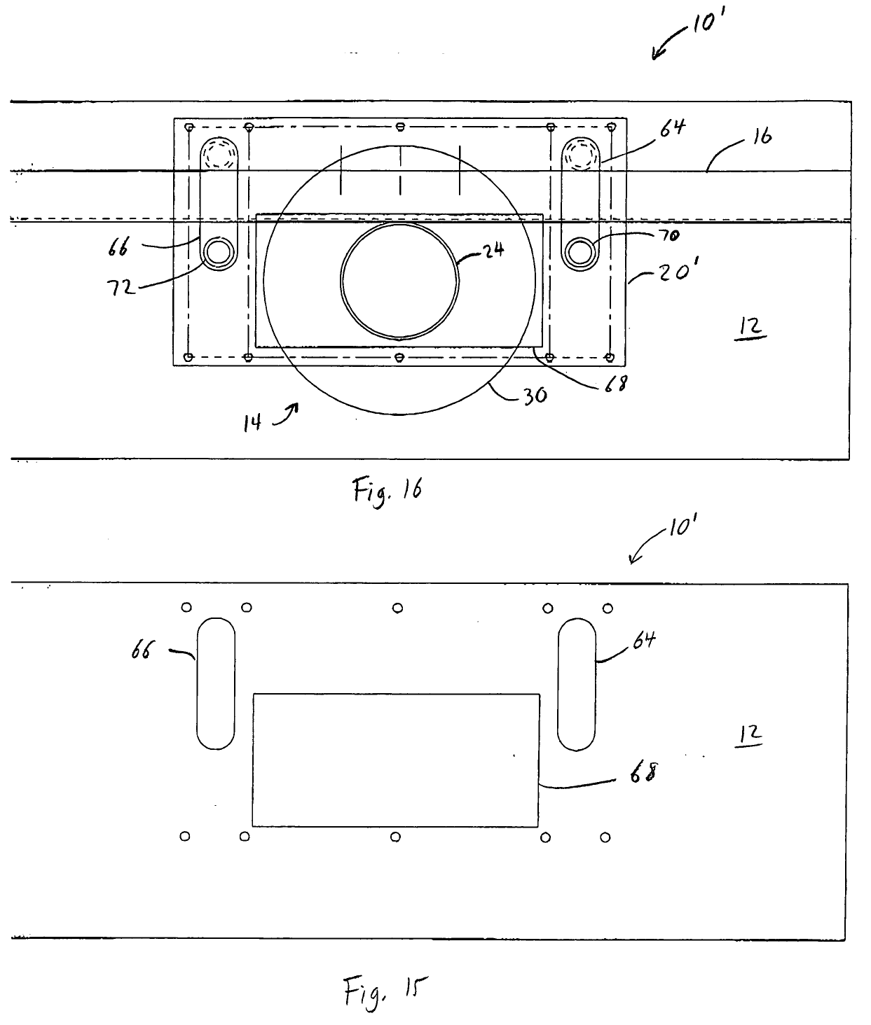

As shown in FIG. 11, a variation of the troughing cone or bell 230 is shown and is indicated in its entirety at 430. As with cone 230, cone 430 is journaled on the outer surface of the pulley 224 so that the cone 230 is free to rotate independently of the pulley 224. However, troughing cone 430 is split into an inner cone portion 430a and an outer cone portion 430b with these cone portions being rotatable on the pulley 224 independently of one another. In this manner the two cone portions can better match the surface speed of the upwardly angled portions of the conveyor belt bearing on the cone portions thereby to minimize the slippage between the cone portions and the belt. This will reduce wear on the belt and on the troughing cones. Of course, those skilled in the art will recognize that the troughing may be divided into more than two portions to even better match the surface speed of the conveyor belt as it is supported on the troughing cone. Of course, the inner and outer portions 430a, 430b are journaled by suitable bearing material, such as an ultra high molecular weight polyethylene or the like.

In FIG. 11, it will be particularly noted that the inner cone portion 430a has a generally cylindrical bore extension 480 that bears on the bearing surface 470. The extension has a radialily inwardly extending flange 482 that is sandwiched between two pieces of bearing material such that the flange 482 (and thus the inner cone 430a) is held in fixed axial position with respect to the pulley 224, but such that the inner cone portion is free to rotate with respect to the pulley 224. Likewise, the outer cone portion 430b is axially held in place with respect to the pulley 224 by means of end plate 472, which is held captive between bearing block 482 and 472b. In this manner the outer cone portion is free to rotate with respect to both the pulley 224 and the inner cone portion.

Referring to FIGS. 12-13, a variation of the present invention provides that rectangular access panels 20′ with one side having a dimension smaller than the outer diameter of the cone 30 may be used. In this manner, the cone 30 may be removed from the conveyor assembly 10 by removing a cone 30 from the pulley 14 and then removing the cone 30 through the opening in the side rails 12 formerly covered by the access panel 20. Next, the pulley assembly 24 and second cone 30 are removed through the opening.

Referring to FIG. 15-16, there is shown a modified conveyor assembly 10′. The modified conveyor assembly 10′ is identical to prior-described conveyor assemblies with the addition of two obround slots 64, 66 located on either side of opening 68 within both sidewalls 12 of the conveyor assembly 10. The access panel 20′ is also large enough to cover the obround slots 64, 66 when the panel 20′ is attached to the side wall 12. When pipes or bars 70, 72 are inserted into the slots 64, 66 of both side walls 12, the bars 70, 72 may be jacked up to raise the conveyor belt 16. In this manner, the cones 30 and pulley 24 may be more easily removed from the conveyor assembly 10 without removing the belt 16.

As various changes could be made in the above constructions without departing from the scope of the invention, it is intended that all matter contained in the above description or shown in the accompanying drawings shall be interpreted as illustrative and not in a limiting sense. For example, if it is desired, the upper reach of the conveyor belt may be flat (not a troughed conveyor) such that the bells 30 can be omitted from the idler roller assembly. This example is merely illustrative of other embodiments that would be readily apparent to those skilled in the art.

1. In an idler pulley for supporting a conveyor belt, said pulley having a generally cylindrical center portion, wherein the improvement comprises: a stub shaft removably mounted to said pulley at each end thereof, said stub shafts being coaxially mounted with respect to said pulley and with respect to one another such that said stub shafts define an axis about which said pulley will rotate, each said stub shaft having a radially disposed flange fixedly secured thereto, said flange being removably mounted to said pulley.

2. The improvement of claim 1 wherein pulley includes a conical outer portion at each end of said center portion with each of said conical portions sloping outwardly of said center portion such that a conveyor belt supported on the upper surfaces of said pulley has a center portion disposed generally horizontally on said center portion and an outer margin supported on each of said conical portions such that said belt is trough-shaped.

3. The improvement of claim 1 wherein said pulley includes an end wall at opposite ends of said shaft; said stub shaft flanges being removably mounted to said end walls.

4. The improvement of claim 3 wherein said end walls are spaced inwardly from the ends of said shaft a depth approximately equal to the width of said stub shaft flange.

5. A conveyor having a pair of spaced supports, one or more idler pulleys journaled with respect to said supports and extending generally transversely with respect to said supports, said idler pulley having shaft end portion extending endwise therefrom and a bearing assembly removably and adjustably mounted relative to said supports at each end of said pulley for rotatably supporting said idler pulley;
each said shaft end portion being removably mounted to said pulley and being substantially coaxially mounted with respect to said pulley and with respect to the shaft end portion attached to the opposite end of said pulley; and
each said shaft end portion having a radially disposed flange fixedly secured thereto and being removably secured to said pulley.

6. The conveyor as set forth in claim 5 wherein each said shaft end portion is a stub shaft.

7. The conveyor as set forth in claim 5 wherein said conveyor is housed within an elongate housing, said supports being at opposite sides of said housing, said housing including at least one access panel in a side wall thereof proximate one of said bearing assemblies, said access panel being removably mounted with respect to said housing so as to provide access to a respective said bearing assembly thereby to facilitate the ready removal of said bearing assembly for said support.

8. The conveyor as set forth in claim 7 wherein after said bearing assembly has been removed, said flange may be removed from said pulley thereby to facilitate replacement of said shaft end portion without having to remove the idler pulley or the shaft end support at the opposite end of said idler pulley.

9. A conveyor having a pair of spaced supports, one or more idler pulleys journaled with respect to said supports and extending generally transversely with respect to said supports, said idler pulley having shaft end portion extending endwise therefrom and a bearing assembly removably and adjustably mounted relative to said supports at each end of said pulley for rotatably supporting said idler pulley;
each said shaft end portion being removably mounted to said pulley and being substantially coaxially mounted with respect to said pulley and with respect to the shaft end portion attached to the opposite end of said pulley; and
each said shaft end portion having a radially disposed flange fixedly secured thereto and being removably secured to said pulley.
